(19) United States
(12) Patent Application Publication
(10) Pub. No.: US 2018/0367369 A1
(43) Pub. Date: Dec. 20, 2018

(54) METHOD AND DEVICE FOR GENERATING ALARM AND ALARM CLEARING INTERRUPTION

(71) Applicant: THOMSON Licensing, Issy-les-Moulineaux (FR)

(72) Inventors: Tianwen XU, Beijing (CN); Juan DU, Beijing (CN); Jiancheng LIU, Beijing (CN)

(21) Appl. No.: 16/060,940

(22) PCT Filed: Dec. 10, 2015
(86) PCT No.: PCT/CN2015/097016

§ 371 Date: Jun. 9, 2018

(51) Int. Cl. H04L 12/24; H04L 12/26; H04B 10/07

(52) U.S. Cl. CPC H04L 41/0631; H04B 10/07; H04L 43/16

(57) ABSTRACT

There is provided a method for generating alarm interruption and alarm clearing interruption for a monitored parameter, the method comprising: generating a first interruption as an alarm interruption for the monitored parameter if the monitored parameter increases to exceed a high threshold or decreases to be lower than a low threshold, the low threshold being stored in a first specified memory address and having a first low alarm value and the high threshold being stored in a second specified memory address and having a first high alarm value; wherein the method further comprising: in response to the first interruption, writing a second low alarm value being same as the first high alarm value into the first specified memory address as a modified low threshold if the alarm interruption is a high alarm interruption, and writing a second high alarm value being same as the first low alarm value into the second specified memory address as a modified high threshold if the alarm interruption is a low alarm interruption; generating a second interruption as an alarm clearing interruption for the monitored parameter if the monitored parameter decreases to be lower than the modified low threshold or if the monitored parameter increases to exceed the modified high threshold.

### TECHNICAL FIELD

The present disclosure relates to alarm and alarm clearing report, and particularly to a method for generating alarm and alarm clearing interruption and a device therefor.

### BACKGROUND

ITU-T (International Telecommunication Union-Telecommunication) G984.4/G988 prescribes that both alarm reporting and alarm clearing reporting of diagnostic monitoring parameters are mandatory functions of GPON (Gigabit Passive Optical Network) ONU/ONT (Optical Network Unit/Terminal) for interoperation with GPON OLT (Optical Line Terminal). The diagnostic monitoring parameters may, for example, include 1490 nm RSSI (Received Signal Strength Indicator), 1555 nm RSSSI, temperature and voltage, etc. That is, the GPON ONU/ONT must support a function of reporting or signaling alarm and alarm clearing for its diagnostic monitoring parameters to the OLT.

Currently, a triplexer (a three-port to one-port multiplexer) in the ONU/ONT only provides a hardware interruption for alarm based on which the ONU/ONT can detect the alarm. That is, a monitored parameter shall be within a normal range of values in normal operation state. But if the monitored parameter exceeds a high threshold value of the normal range or lowers than a low threshold value of the normal range, a hardware interruption is sent out. Herein, a hardware interrupt is a signal to the processor emitted by a hardware indicating a detected event. Hardware interrupts are implemented by using electronic alerting signals that are sent to the processor from a hardware device or circuit, which is a part of the ONU/ONT. Hardware interrupt causes the processor to read data in a storage of the hardware device. Compared to hardware interrupt, a software interrupt is caused either by an exceptional condition in the processor itself, or a special instruction in the instruction set which causes an interrupt when it is executed. However, the triplexer cannot provide the hardware interruption for alarm clearing due to limited EEPROM size in the triplexer, limited processor performance in the triplexer, and limited registers reserved for customization, etc. In other words, the triplexer of this kind does not send out hardware interruption when the monitored parameter returns back to normal range. More specifically, when the monitored parameter increases to exceed the low threshold value or decreases to lower than the high threshold value, it does not send out hardware interruption.

Software implementation (for example, software polling) for alarm clearing is an alternative solution for reporting the alarm clearing. However, such software polling consumes a lot of ONU/ONT CPU resource, and requires reading the EEPROM on the triplexer via the I²C interface periodically and frequently. And consequently, it will speed up aging of a whole chipset of the triplexer. On the other hand, such software polling for detecting alarm clearing is not instantaneous but has a polling delay.

Therefore, it is necessary for the triplexer to provide hardware interruption for the alarm clearing based on the existing hardware structure of the triplexer.

### SUMMARY

A method for generating alarm and alarm clearing interruption and an optical network unit are provided, such that hardware interruption can be provided for both alarm and alarm clearing based on the hardware structure of the existing ONU/ONT.

According to one aspect of embodiments of the present disclosure, there is provided a method for generating alarm interruption and alarm clearing interruption for a monitored parameter, the method comprising: generating a first interruption as an alarm interruption for the monitored parameter if the monitored parameter increases to exceed a high threshold or decreases to be lower than a low threshold, the low threshold being stored in a first specified memory address and having a first low alarm value and the high threshold being stored in a second specified memory address and having a first high alarm value; wherein the method further comprising: in response to the first interruption, writing a second low alarm value being same as the first high alarm value into the first specified memory address as a modified low threshold if the alarm interruption is a high alarm interruption, and writing a second high alarm value being same as the first low alarm value into the second specified memory address as a modified high threshold if the alarm interruption is a low alarm interruption; generating a second interruption as an alarm clearing interruption for the monitored parameter if the monitored parameter decreases to be lower than the modified low threshold or if the monitored parameter increases to exceed the modified high threshold.

According to another aspect of the embodiments of the present disclosure, there is provided a device for generating alarm interruption and alarm clearing interruption for a monitored parameter, comprising: a multiplexer comprising one or more EEPROMs, and being configured to generating an interruption for the monitored parameter if the monitored parameter increases to exceed a high threshold or decreases to be lower than a low threshold, the low threshold being stored in a first specified memory address in the EEPROMs and having a first low alarm value and the high threshold being stored in a second specified memory address in the EEPROMs and having a first high alarm value; one or more processors; and one or more storage means storing computer program instructions; wherein the low threshold has a first low alarm value and the high threshold has a first high alarm value, the interruption generated by the multiplexer is an alarm interruption for the monitored parameter; the computer program instructions are executed by the one or more processors to: write a second low alarm value being same as the first high alarm value into the first specified memory address such that the low threshold has the second low alarm value if the alarm interruption is a high alarm interruption, or write a second high alarm value being same as the first low alarm value into the second specified memory address such that the high threshold has the second high alarm value if the alarm interruption is a low alarm interruption; the interruption generated by the multiplexer in response to that the monitored parameter decreases to be lower than the modified low threshold or that the monitored parameter increases to exceed the modified high threshold is interpreted as an alarm clearing interruption relative to the alarm interruption.

### BRIEF DESCRIPTION OF THE DRAWINGS

In order to more clearly describe the technical solutions of the embodiments of the present disclosure or the prior art, drawings necessary for describing the embodiments of the present disclosure or the prior art are simply introduced as follows. It should be obvious for those skilled in the art that the drawings described as follows only illustrate some embodiments of the present disclosure and other drawings can be obtained according to these drawings without paying any inventive efforts.

FIG. 1 is a schematic diagram of alarm and alarm clearing trigger scheme in an ONT/ONU according to the embodiments of the present disclosure;

FIG. 2 is a schematic diagram of structure of the ONT/ONU according to the embodiments of the present disclosure;

FIG. 3 is a schematic flowchart of a method for generating alarm and alarm clearing interruption according to the embodiments of the present disclosure; and

FIG. 4 is a schematic diagram of operational modules in the ONU/ONT according to the embodiments of the present disclosure.

### DETAILED DESCRIPTION OF THE PREFERRED EMBODIMENTS

To illustrate the technical solutions of embodiments of the present disclosure clearly and fully, hereinafter, detailed descriptions will be made to the embodiments of the present disclosure in connection with the accompanying drawings. Obviously, the embodiments as described are only a part of the embodiments of the present disclosure, and are not all the embodiments of the present disclosure. All the other embodiments which are obtained by those skilled in the art based on the embodiments of the present disclosure without paying any inventive labor fall into the protection of the present disclosure.

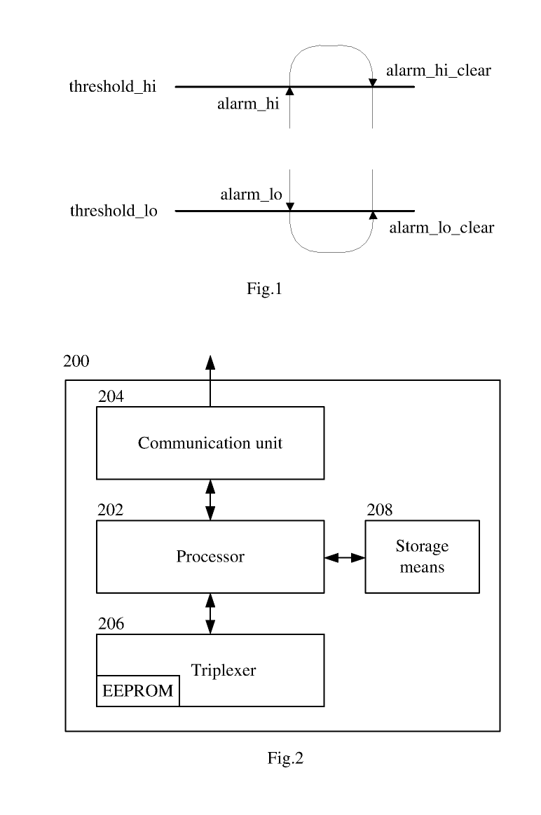

At first, alarm and alarm clearing trigger scheme in an ONT/ONU according to the embodiments of the present disclosure will be described briefly with reference to FIG. 1.

As shown in FIG. 1, a high alarm threshold threshold_hi and a low alarm threshold threshold_lo are set to define a normal operating range for a specific diagnostic monitoring parameter such as 1490 nm RSSI, 1555 nm RSSI, temperature or voltage. Each diagnostic monitoring parameter corresponds to a set of a high alarm threshold and a low alarm threshold. When a detected realtime value of the specific diagnostic monitoring parameter is increased to be higher than the high alarm threshold threshold_hi or is decreased to be lower than the low alarm threshold threshold_lo, a hardware interruption for alarm alarm_hi or alarm_lo should be generated. On the other hand, when the detected realtime value of the specific diagnostic monitoring parameter is decreased to change from higher than the high alarm threshold threshold_hi to lower than the high alarm threshold threshold_hi or is increased to change from lower than the low alarm threshold threshold_lo to higher than the low alarm threshold, a hardware interruption for alarm clearing alarm_hi_clear or alarm_lo_clear should be generated.

Taking that the specific diagnostic monitoring parameter is a temperature of the ONT/ONU with a high alarm threshold of 60° C. and a low alarm threshold of −25° C. as an example, operation of the ONT/ONU according to the embodiments of the present disclosure will be described simply.

When the detected realtime value of the temperature keeps increasing due to less cooling or heating and reaches more than 60° C., a high alarm interruption alarm_hi for the temperature will be reported by the ONT/ONU to the OLT. Then, when the detected realtime value of the temperature drops to a value below 60° C. due to cooling or less heating, a high alarm clearing interruption alarm_hi_clear for the temperature will be reported by the ONT/ONU to the OLT.

When the detected realtime value of the temperature keeps decreasing due to cooling or less heating and reaches less than −25° C., a low alarm interruption alarm_lo for the temperature will be reported by the ONT/ONU to the OLT. Then, when the detected realtime value of the temperature rises to a value above −25° C. due to heating or less cooling, a low alarm clearing interruption alarm_lo_clear for the temperature will be reported by the ONT/ONU to the OLT.

Next, structure of an ONU/ONT 200 will be described briefly with reference to FIG. 2.

The ONU/ONT 200 comprises one or more processors 202, one or more communication units 204, a triplexer with one or more EEPROMs 206, and one or more storage means 208. The storage means 208 includes flash, where bootloader, RIP (Routing Information Protocol) and software image are stored.

According to the embodiments of the present disclosure, when the detected realtime value of the temperature keeps increasing and reaches more than 60° C., the triplexer 206 generates a hardware interruption, and the ONU/ONT interprets this hardware interruption as a high alarm interruption alarm_hi; and when the detected realtime value of the temperature drops lower than 60° C., the triplexer generates a new hardware interruption, and the ONU/ONT interprets this new hardware interruption as a high alarm clearing interruption alarm_hi_clear.

According to the embodiments of the present disclosure, when the detected realtime value of the temperature keeps decreasing and reaches lower than −25° C., the triplexer generates a hardware interruption, and the ONU/ONT interprets this hardware interruption as a low alarm interruption alarm_lo; and when the detected realtime value of the temperature rises higher than −25° C., the triplexer generates a new hardware interruption, and the ONU/ONT interprets this new hardware interruption as a low alarm clearing interruption alarm_lo_clear.

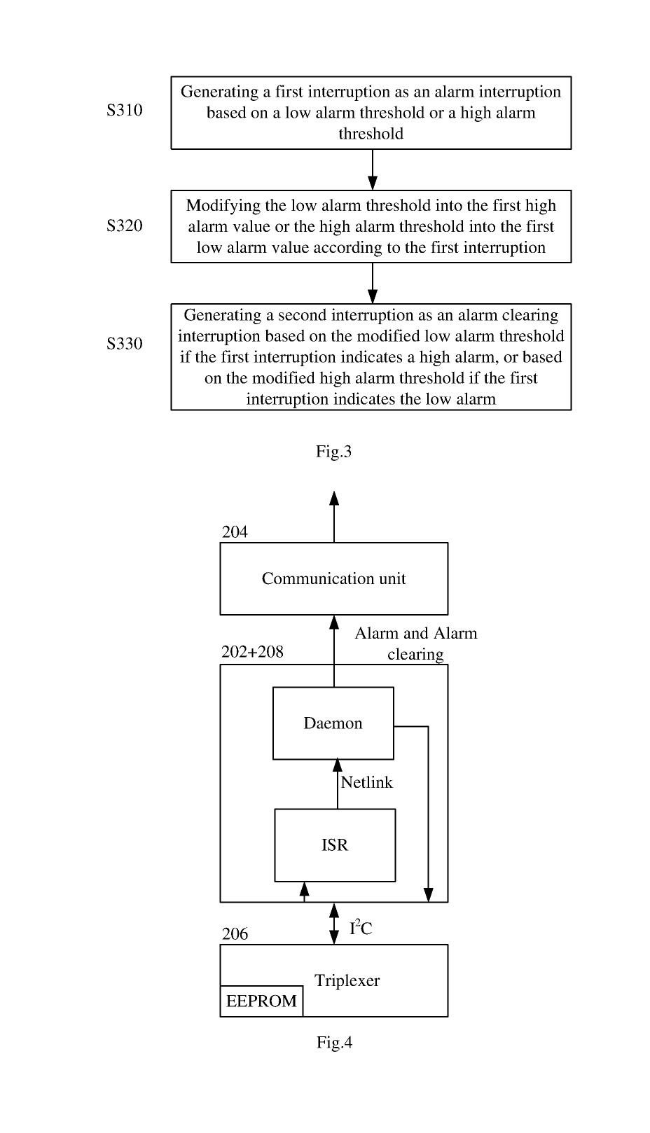

Below, a method for generating alarm interruption and alarm clearing interruption for a diagnostic monitoring parameter according to the embodiments of the present disclosure will be described in detail with reference to FIG. 3.

It should be explained that two storage spaces in the EEPROM are allocated to a specific diagnostic monitoring parameter for storage of a high alarm threshold and a low alarm threshold set for the specific diagnostic monitoring parameter. Here, each of the two storage spaces may comprise threshold (either high threshold or low threshold) for one or more diagnostic monitoring parameters according to actual requirements and may be addressed by a memory address. In other words, the low alarm threshold is stored in a first specified memory address in the EEPROM in the triplexer 206, and the high alarm threshold is stored in a second specified memory address in the EEPROM in the triplexer 206. Initially, the low alarm threshold has a default low alarm value (hereinafter, referred to as a first low alarm value) and the high alarm threshold has a default high alarm value (hereinafter, referred to as a first high alarm value). It shall be noted that it is possible to use one storage space instead of two storage spaces in the EEPROM.

As shown in FIG. 3, at step S310, the triplexer 206 generates a first interruption as an alarm interruption for a specific diagnostic monitoring parameter based on the low alarm threshold or the high alarm threshold.

Temperature is still taken as an example of the specific diagnostic monitoring parameter, and the default low alarm value and the default high alarm value are still set as 60° C. and −25° C. respectively.

For example, when the detected realtime value of the temperature keeps increasing and reaches higher than 60° C., the triplexer 206 sets a high alarm indicator in one bit in the EEPROM allocated to a high alarm interruption for the temperature (the existence of the high alarm indicator indicates that the monitored parameter exceeds the high threshold), and generates and sends a hardware interruption to the processor 202. In this case, the processor 202 triggers an interrupt service routine ISR, in which the processor 202 reads the EEPROM for example via an 1²C interface to determine why the hardware interruption has been generated, that is, what has happened. Here, the processor 202 determines that the generated alarm interruption is a high alarm interruption alarm_hi. This Alarm_High indicator will be removed when the realtime value of the temperature decreases and be lower than the original temperature_high_threshold, the corresponding bit will be set as 0 by the triplexer.

On the other hand, when the detected realtime value of the temperature keeps decreasing and drops lower than −25° C., the triplexer 206 sets a low alarm indicator in another bit in the EEPROM allocated to a low alarm interruption for the temperature, and generates and sends a hardware interruption to the processor 202. In this case, the processor 202 also triggers the ISR, in which the processor 202 reads the EEPROM for example via an I²C interface to determine why the hardware interruption is generated. Here, the processor 202 determines that the generated alarm interruption is a low alarm interruption alarm_lo.

In order for clear description, said one bit in the EEPROM allocated to the low alarm interruption for the temperature will be referred to as a first bit in the EEPROM, and said another bit in the EEPROM allocated to the high alarm interruption for the temperature will be referred to as a second bit in the EEPROM. It should be understood that the terms of “first” and “second” are just used to distinguish the bit for the low alarm interruption and the bit for the high alarm interruption, but do not indicate locations of the two bits in the EEPROM and location relationship between the two bits.

For example, there are two EEPROMs in the triplexer, named A0 and A2. Each of the two EEPROMs has 128 types, each byte has 8 bits, and 2 bytes in A2 for example 70h and 71h in A2 are used to indicate types of alarms, for example, alarm_hi for temperature, alarm_lo for temperature, alarm_hi for voltage, alarm_lo for voltage, alarm_hi for 1490 RSSI, alarm_lo for 1490 RSSI, alarm_hi for 1555 RSSI, alarm_lo for 1555 RSSI, etc.

At step S320, the processor 202 writes a second low alarm value equaling to the first high alarm value into the first specified memory address for storing low threshold value in the EEPROM as a modified low alarm threshold if the first interruption is a high alarm interruption alarm_hi, or writes a second high alarm value being same as the first low alarm value into the second specified memory address for storing high threshold value as a modified high alarm threshold if the first interruption is a low alarm interruption alarm_lo. Herein, the first high alarm value and the first low alarm value are stored in memory, and used to restore the original values in the first specified memory address and the second specified memory address after they are changed.

At step S330, the triplexer 206 generates a second interruption as an alarm clearing interruption for the diagnostic monitoring parameter based on the modified low alarm threshold if the first interruption is the high alarm interruption alarm_hi, or based on the modified high alarm threshold if the first interruption is the low alarm interruption alarm_lo.

On one hand, when the generated alarm interruption (first interruption) is the high alarm interruption alarm_hi, the processor 202 writes the second low alarm value being same as the first high alarm value into the first specified memory address to provide the modified low alarm threshold at step S320. In this case, the high alarm threshold in the second specified memory address may be unchanged, or the processor 202 may also write a second high alarm value chosen within a range from the first high alarm value to a high boundary value into the second specified memory address to provide the modified high alarm threshold. The high boundary value may be set or determined according to the size of the storage space (i.e. number of bits) for the high alarm threshold.

In this case, when the detected realtime value of the temperature drops lower than 60° C., the triplexer 206 determines that the detected realtime value of the temperature is lower than the modified low alarm threshold 60° C., sets a low alarm indicator in the first bit in the EEPROM allocated to the low alarm interruption for the temperature, and generates and sends the second hardware interruption to the processor 202. In this case, the processor 202 also triggers the ISR, in which the processor 202 reads the EEPROM for example via an I²C interface to determine why the hardware interruption is generated. Here, the processor 202 determines that the generated second interruption is a low alarm interruption. In this case, since the processor 202 knows that the low alarm threshold has been modified to the first high alarm value, it interprets the generated second interruption as a high alarm clearing interruption alarm_hi_clear relative to the high alarm interruption alarm_hi.

On the other hand, when the generated alarm interruption (first interruption) is the low alarm interruption alarm_lo, the processor 202 writes the second high alarm value being same as the first low alarm value into the second specified memory address to provide the modified high alarm threshold at step S320. In this case, the low alarm threshold in the first specified memory address may be unchanged, or the processor 202 may also write a second low alarm value in a range from a low boundary value to the first low alarm value into the first specified memory address to provide the modified low alarm threshold. The low boundary value may be set or determined according to the size of the storage space for the low alarm threshold.

In this case, when the detected realtime value of the temperature rises higher than −25° C., the triplexer 206 determines that the detected realtime value of the temperature is higher than the modified high alarm threshold −25° C., sets a high alarm indicator in the second bit in the EEPROM allocated to the high alarm interruption for the temperature, and generates and sends the second hardware interruption to the processor 202. In this case, the processor 202 also triggers the ISR, in which the processor 202 reads the EEPROM for example via an I²C interface to determine why the hardware interruption is generated. Here, the processor 202 determines that the generated second interruption is a high alarm interruption. In this case, since the processor 202 knows that the low alarm threshold has been modified to the first high alarm value, it interprets the generated second interruption as a low alarm clearing interruption alarm_lo_clear relative to the low alarm interruption alarm_lo.

According to the embodiments of the present disclosure, the processor 202 knows the current value of the low alarm threshold and the current value of the high alarm threshold and the processor 202 knows that an currently generated/incoming interruption is generated by the current value of the low alarm threshold or the current value of the high alarm threshold, so the processor 202 can interpret the incoming interruption properly based on the current value of the low alarm threshold when the incoming interruption is generated by the low alarm threshold, or based on the current value of the high alarm threshold when the incoming interruption is generated by the high alarm threshold.

When the processor 202 determines that the generated interruption is generated by the current value of the low alarm threshold and the current value of the low alarm threshold is the first low alarm value, the processor 202 determines that the generated interruption is the low alarm interruption alarm_lo.

When the processor 202 determines that the generated interruption is generated by the current value of the low alarm threshold and the current value of the low alarm threshold is the second low alarm value being same as the first high alarm value, the processor 202 determines that the generated interruption is the low alarm clearing interruption alarm_lo_clear. Herein, there is another method for the processor to determine whether the monitored parameter is within the normal operating range when receiving a hardware interruption. In a method, the processor first determines if the traversed threshold has been changed or not when receiving a hardware interruption. If yes, then it means the monitored parameter is within the normal operating range now.

When the processor 202 determines that the generated interruption is generated by the current value of the high alarm threshold and the current value of the high alarm threshold is the first high alarm value, the processor 202 determines that the generated interruption is the high alarm interruption alarm_hi.

When the processor 202 determines that the generated interruption is generated by the current value of the high alarm threshold and the current value of the high alarm threshold is the second high alarm value being same as the first low alarm value, the processor 202 determines that the generated interruption is the high alarm clearing interruption alarm_hi_clear.

According to the embodiments of the present disclosure, a flag is allocated to the specified diagnostic monitoring parameter in the storage means, and the flag is reset for example to 0 initially. When the processor 202 is notified of the arrival of the first interruption, the processor 202 reads the flag and determines that the incoming first interruption is an alarm interruption (particularly, low alarm interruption or high alarm interruption), and then the processor 202 sets the flag for example to 1 to indicate that an alarm interruption has been generated and an alarm clearing interruption is expected. Next, the processor 202 modified the value of the low alarm threshold or the value of the high alarm threshold as described above.

Then, when the processor 202 is notified of the arrival of the second interruption, the processor 202 reads the flag and determines that the incoming second interruption may be an alarm clearing interruption. Furthermore, the processor 202 determines that the incoming second interruption is the high alarm clearing interruption, when it determines that the first interruption is the high alarm interruption and the incoming second interruption is generated by the low alarm threshold (that is, modified low alarm threshold). And it sets the flag to 0. On the other hand, the processor 202 determines that the incoming second interruption is the low alarm clearing interruption, when it determines that the first interruption is the low alarm interruption and the incoming second interruption is generated by the high alarm threshold (that is, modified high alarm threshold).

Next, examples for calculation of the second low alarm value and the second high alarm value will be described.

When the first interruption is the high alarm interruption, the second low alarm value can be determined based on the first high alarm value (60° C.) and the first low alarm value (−25° C.). Optionally, the second low alarm value can be directly set to the first high alarm value (60° C.). Alternatively, the second low alarm value can be calculated based on the first low alarm value and a difference between the first high alarm value and the first low alarm value, particularly the second low alarm value is calculated by adding the difference (85° C.) to the first low alarm value (−25° C.). The difference can be calculated in advance and can be stored, or can be calculated in real time.

Furthermore, the second high alarm value can also be calculated based on the first high alarm value (60° C.) and the first low alarm value (−25° C.), particularly based on the first high alarm value and the difference. Particularly, a calculated high alarm value is obtained by adding the difference (85° C.) to the first high alarm value (60° C.), the second high alarm value is set to the high boundary value (127° C.) if the calculated high alarm value (145° C.) is higher than the high boundary value (127° C.), otherwise the second high alarm value is set to the calculated high alarm value.

On the other hand, when the first interruption is the low alarm interruption, the second high alarm value can be determined based on the first high alarm value and the first low alarm value. Optionally, the second high alarm value can be directly set to the first low alarm value (−25° C.). Alternatively, the second high alarm value can be calculated based on the first high alarm value and a difference between the first high alarm value and the first low alarm value, particularly the second high alarm value is calculated by subtracting the difference (85° C.) from the first high alarm value (60° C.).

Furthermore, the second low alarm value can also be calculated based on the first high alarm value and the first low alarm value, particularly based on the first low alarm value and the difference. Particularly, a calculated low alarm value is obtained by subtracting the difference (85° C.) from the first low alarm value (−25° C.), the second low alarm value is set to the low boundary value (−127° C.) if the calculated low alarm value (−110° C.) is lower than the low boundary value (−127° C.), otherwise the second low alarm value is set to the calculated low alarm value (−110° C.).

Below, an exemplary implementation of the method for generating alarm interruption and alarm clearing interruption will be described in detail with reference to FIG. 4.

According to the embodiments of the present disclosure, a Deamon routine is always running on the processor 202, when the ISR (the processor 202) determines that the generated alarm interruption is an alarm interruption (the high or low alarm interruption), it notifies the Daemon about the arrival of the high (or low) alarm interruption for example via a Netlink message, and then the Daemon (the processor 202) will perform the operation of calculating of the second low or high alarm value and modifying the low or high alarm threshold. The Daemon running on the processor 202 may further comprise a triplexer Daemon and an OMCI (Optical Network Unit Management Control Interface) Daemon. In order not to obscure the embodiments of the present disclosure, only operations of the Daemon related to the inventive concept of the present disclosure are described but other operations of the Daemon are omitted herein.

Initially, the low alarm threshold is set to the first low alarm value and the high alarm threshold is set to the first high alarm value, and the flag is reset to 0.

### First Example

When the detected realtime value is higher than the first high alarm value (60° C.), the triplexer 206 sets a high alarm indicator in the second bit in the EEPROM, and generates and sends a hardware interruption (first hardware interruption) to the processor 202.

The processor 202 triggers the ISR. In the ISR, the processor 202 reads the EEPROM in the triplexer for example via I²C interface and determines that the currently generated hardware interruption is the high alarm interruption. Furthermore, the ISR further notifies the Daemon about the arrival of the high alarm interruption of the specified diagnostic monitoring parameter for example via a Netlink message. In addition, after reading the EEPROM in the triplexer, in the ISR, the processor 202 resets the second bit in the EEPROM, that is, clears the high alarm indicator in the second bit in the EEPROM.

After being notified the arrival of the high alarm interruption, the Daemon determines that the high alarm interruption is a real high alarm interruption since the flag is 0, sets the flag to 1, and writes the second low alarm value (60° C.) being same as the first high alarm value into the first specified memory address to provide the modified low alarm threshold. Optionally, the Daemon can further determine the second high alarm value as described above and writes the second high alarm value into the second specified memory address to provide the modified high alarm threshold. Then, the Daemon generates a report for the high alarm interruption, indicates the communication unit 204 to send the report to an optical light terminal OLT, and waits for a low alarm threshold for the specified diagnostic monitoring parameter.

Next, when the detected realtime value of the temperature is still higher than the modified high alarm threshold (equal to or higher than 60° C.), the triplexer 206 sets a high alarm indicator in the second bit in the EEPROM, and generates and sends a hardware interruption to the processor 202, the ISR reads the EEPROM, resets the second bit in the EEPROM, determines the currently generated hardware interruption is the high alarm interruption, and notifies the Daemon. The Daemon determines that the currently generated hardware interruption is not a low alarm interruption, interprets that the currently generated hardware interruption is still the high alarm interruption, and keeps waiting for the low alarm interruption.

On the other hand, when the detected realtime value of the temperature drops lower than the modified low alarm threshold (60° C.), the triplexer 206 determines that the detected realtime value of the specified diagnostic monitoring parameter is lower than the modified low alarm threshold, sets a low alarm indicator in the first bit in the EEPROM, and generates and sends a hardware interruption to the processor 202, the ISR reads the EEPROM, resets the first bit in the EEPROM, determines the currently generated hardware interruption is a low alarm interruption, and notifies the Daemon. The Daemon determines that the currently generated hardware interruption is a low alarm interruption, and interprets the currently generated hardware interruption as the high alarm clearing interruption relative to the high alarm interruption, generates a report for the high alarm clearing interruption, and indicates the communication unit 204 to send the report to the OLT. In addition, The Daemon clears the flag (resets the flag to 0) and writes the first low alarm value into the first specified memory address, and writes the first high alarm value into the second specified memory address if necessary.

### Second Example

When the detected realtime value is lower than the first low alarm value, the triplexer 206 sets a low alarm indicator in the first bit in the EEPROM, and generates and sends a hardware interruption (first hardware interruption) to the processor 202.

The processor 202 triggers the ISR. In the ISR, the processor 202 reads the EEPROM in the triplexer for example via I²C interface and determines that the currently generated hardware interruption is the low alarm interruption. Furthermore, the ISR further notifies the Daemon about the arrival of the low alarm interruption of the specified diagnostic monitoring parameter via a Netlink message. In addition, after reading the EEPROM in the triplexer, in the ISR, the processor 202 resets the second bit in the EEPROM, that is, clears the low alarm indicator in the first bit in the EEPROM.

After being notified the arrival of the low alarm interruption, the Daemon determines that the low alarm interruption is a real low alarm interruption since the flag is 0, sets the flag to 1, and writes the second high alarm value (−25° C.) being same as the first low alarm value into the second specified memory address to provide the modified high alarm threshold (−25° C.). Optionally, the Daemon can further determine the second low alarm value and writes the second low alarm value into the second specified memory address to provide the modified low alarm threshold. Then, the Daemon generates a report for the low alarm interruption, indicates the communication unit 204 to send the report to the OLT, and waits for a high alarm interruption for the specified diagnostic monitoring parameter.

Next, when the detected realtime value of the temperature is still lower than the modified low alarm threshold (equal to or lower than −25° C.), the triplexer 206 sets a low alarm indicator in the first bit in the EEPROM, and generates and sends a hardware interruption to the processor 202. The ISR reads the EEPROM, resets the first bit in the EEPROM, determines the currently generated hardware interruption is the low alarm interruption, and notifies the Daemon. The Daemon determines that the currently generated hardware interruption is not a high alarm interruption, interprets that the currently generated hardware interruption is still the low alarm interruption, and keeps waiting for the high alarm interruption.

On the other hand, when the detected realtime value of the temperature is higher than the modified high alarm threshold (−25° C.), the triplexer 206 sets a high alarm indicator in the second bit in the EEPROM, and generates and sends a hardware interruption to the processor 202. The ISR reads the EEPROM, resets the second bit in the EEPROM, determines the currently generated hardware interruption is a high alarm interruption, and notifies the Daemon. The Daemon determines that the currently generated hardware interruption is a high alarm interruption, interprets the currently generated hardware interruption as the low alarm clearing interruption relative to the low alarm interruption, generates a report for the low alarm clearing interruption, and indicates the communication unit 204 to send the report to the OLT. In addition, The Daemon clears the flag set (resets the flag to 0) and writes the first high alarm value into the second specified memory address, and writes the first low alarm value into the first specified memory address if necessary.

According to the embodiments of the present disclosure, both alarm and alarm clearing can be generated by hardware interruptions based on the hardware configuration of the existing ONT/ONU, and can be reported to the OLT. The generated alarm report and alarm clearing report are both instant without any polling delay.

In addition, only when the flag is set or reset, the first specified memory address and the second specified memory address are written via 12C interface, such that access to the EEPROM through the 12C interface is not performed periodically and frequently, and thus the lifespan of the whole chipset of the triplex or even the lifespan of the ONT/ONU can be extended.

According to a variant of the embodiments, it is provided a computer program comprising program code instructions executable by a processor for implementing a method in above embodiments. It is also provided a computer program product which is stored on a non-transitory computer readable medium and comprises program code instructions executable by a processor for implementing a method in above embodiments.

It should be appreciated that the above embodiments are only for illustrating the principle of the present disclosure, and in no way limit the scope of the present disclosure. It will be obvious that those skilled in the art may make modifications, variations and equivalences to the above embodiments without departing from the spirit and scope of the present disclosure as defined by the following claims. Such variations and modifications are intended to be included within the spirit and scope of the present disclosure.

1-10. (canceled).

11. A method for generating an alarm interruption comprising a high alarm interruption and a low alarm interruption and an alarm clearing interruption for a parameter, the method comprising:
generating the low alarm interruption for the parameter when the parameter decreases to be lower than a first low alarm value being stored in a first memory address, or the high alarm interruption for the parameter when the parameter increases to exceed a first high alarm value being stored in a second memory address;
wherein the method further comprising:
in response to the low alarm interruption, writing a second high alarm value being same as the first low alarm value into the second memory address, or in response to the high alarm interruption, writing a second low alarm value being same as the first high alarm value into the first memory address; and
generating the alarm clearing interruption for the parameter when the parameter decreases to be lower than the second low alarm value or when the parameter increases to exceed the second high alarm value.

12. The method of claim 11, further comprising:
reporting the low alarm interruption or the high alarm interruption after generating the low alarm interruption or the high alarm interruption; and
reporting the alarm clearing interruption after generating the alarm clearing interruption.

13. The method of claim 11, wherein
in response to the high alarm interruption, the second high alarm value is in a range from the first high alarm value to a high boundary value; and
in response to the low alarm interruption, the second low alarm value is in a range from a low boundary value to the first low alarm value.

14. The method of claim 13, further comprising:
in response to the high alarm interruption, determining the second high alarm value based on the first high alarm value and a difference between the first high alarm value and the first low alarm value and writing the second high alarm value into the second memory address; or
in response to the high alarm interruption, determining the second low alarm value based on the first low alarm value and the difference between the first high alarm value and the first low alarm value and writing the second low alarm value into the first memory address.

15. The method of claim 14, wherein
said determining the second high alarm value comprises: adding the difference to the first high alarm value to obtain a calculated high alarm value, setting the second high alarm value to the high boundary value if the calculated high alarm value is higher than the high boundary value, otherwise setting the second high alarm value to the calculated high alarm value; and
said determining the second low alarm value comprises: subtracting the difference from the first low alarm value to obtain a calculated low alarm value, setting the second low alarm value to the low boundary value if the calculated low alarm value is lower than the low boundary value, otherwise setting the second low alarm value to the calculated low alarm value.

16. The method of claim 11, wherein
said generating the low alarm interruption or the high alarm interruption comprises: determining the high alarm interruption or the low alarm interruption, setting a flag for the parameter, and determining an expected alarm interruption, the expected alarm interruption being the high alarm interruption in response to the low alarm interruption and the low alarm interruption in response to the high alarm interruption;
said generating the alarm clearing interruption comprises: after the low alarm interruption or the high alarm interruption, determining another high alarm interruption or another low alarm interruption, determining the alarm clearing interruption when the another low alarm interruption or the another high alarm interruption is same as the expected alarm interruption, and resetting the flag for the parameter.

17. The method of claim 11, further comprising:
after generating the alarm clearing interruption, writing the first low alarm value into the first memory address as the low threshold and the first high alarm value into the second memory address as the high threshold.

18. A device for generating an alarm interruption comprising a high alarm interruption and a low alarm interruption and an alarm clearing interruption for a parameter, comprising:
a hardware interruption generator comprising one or more memories, and being configured to generating the low alarm interruption for the parameter when the parameter decreases to be lower than a first low alarm value being stored in a first memory address in the memories, or the high alarm interruption for the parameter when the parameter increases to exceed a first high alarm value being stored in a second memory address in the memories;
one or more processors being configured to:
in response to the low alarm interruption, write a second high alarm value being same as the first low alarm value into the second memory address, or in response to the high alarm interruption, write a second low alarm value being same as the first high alarm value into the first memory address; and
generate the alarm clearing interruption for the parameter when the parameter decreases to be lower than the second low alarm value or when the parameter increases to exceed the second high alarm value.

19. The device of claim 18, wherein the one or more processors further configured to:
report the low alarm interruption or the high alarm interruption after the low alarm interruption or the high alarm interruption is generated; and
report the alarm clearing interruption after the alarm clearing interruption is generated.

20. The device of claim 18, wherein the one or more processors further configured to:
in response to the high alarm interruption, add a difference between the first high alarm value and the first low alarm value to the first high alarm value to obtain a calculated high alarm value, set the second high alarm value to a high boundary value if the calculated high alarm value is higher than the high boundary value, otherwise set the second high alarm value to the calculated high alarm value;
in response to low alarm interruption, subtract the difference from the first low alarm value to obtain a calculated low alarm value, set the second low alarm value to a low boundary value if the calculated low alarm value is lower than the low boundary value, otherwise set the second low alarm value to the calculated low alarm value.

21. non-transitory computer readable storage medium comprising program code instructions executable by a processor for implementing the steps of a method according to claim 11.

22. Computer program product which is stored on a non-transitory computer readable medium and comprises program code instructions executable by a processor for implementing the steps of a method according to claim 11.

23. A optical network unit or optical network terminal comprises a device for generating an alarm interruption according to claim 18.
